(19) United States
(12) Patent Application Publication
(10) Pub. No.: US 2020/0185691 A1
(43) Pub. Date: Jun. 11, 2020

(54) SEALED BATTERY AND ASSEMBLED BATTERY

(71) Applicant: TOYOTA JIDOSHA KABUSHIKI KAISHA, Toyota-shi (JP)

(72) Inventors: Koji UMEMURA, Okazaki-shi (JP); Kazuyuki KUSAMA, Nagoya-shi (JP)

(73) Assignee: TOYOTA JIDOSHA KABUSHIKI KAISHA, Toyota-shi (JP)

(21) Appl. No.: 16/693,505

(22) Filed: Nov. 25, 2019

(30) Foreign Application Priority Data
Dec. 10, 2018 (JP) 2018-231018

(51) Int. Cl. H01M 2/26; H01M 2/30; H01M 2/06; H01M 4/66

(52) U.S. Cl. CPC H01M 2/263; H01M 2/30; H01M 2004/027; H01M 4/662; H01M 2/06

(57) ABSTRACT

The present disclosure provides a technique that enables a contraction of a separator due to generation of heat by an electrode body to be appropriately suppressed and an internal short circuit due to a contraction of the separator to be preferably prevented. In a sealed battery 1 disclosed herein, a core portion 22 is formed such that a distance L1 and a distance L2 satisfy 1<L1/L2<1.8, the distance L1 being a shortest distance between a positive electrode side edge portion 22a that is a side edge portion of the core portion 22 on a side of a positive electrode connecting portion 24 and a side edge portion on a side of the core portion 22 of a positive electrode-connected location 32 and the distance L2 being a shortest distance between a negative electrode side edge portion 22b that is a side edge portion of the core portion 22 on a side of a negative electrode connecting portion 26 and a side edge portion on the side of the core portion 22 of a negative electrode-connected location 42. Accordingly, an occurrence of a localized temperature rise in a specific region can be suppressed and an internal short circuit in accordance with a thermal contraction of a separator can be more preferably prevented.

### CROSS REFERENCE TO RELATED APPLICATIONS

The present application claims priority on the basis of Japanese Patent Application No. 2018-231018 filed in Japan on Dec. 10, 2018, the entire contents of which are incorporated herein by reference.

### BACKGROUND

### 1. Technical Field

The present disclosure is related to a sealed battery and an assembled battery including a plurality of the sealed batteries as unit cells.

### 2. Description of the Related Art

Lithium ion secondary batteries and other secondary batteries are growing in importance as vehicle-mounted power supplies and as power supplies for personal computers, mobile phones, and the like. In particular, lithium ion secondary batteries being lightweight and capable of attaining high energy density are widely used as high-output vehicle-mounted power supplies. A typical structure of such secondary batteries is a sealed battery.

An example of the sealed battery will now be described with reference to FIG. 9. In a sealed battery 100 shown in FIG. 9, an electrode body 120 is housed in a case 110. Although not shown, the electrode body 120 is a wound electrode body fabricated by winding a laminate in which a positive electrode and a negative electrode are laminated via an insulating separator. The positive electrode and the negative electrode respectively have a foil-like current collector and a mixture layer formed on a surface of the current collector. In addition, a core portion 122 where the mixture layers of the positive and negative electrodes oppose each other is formed at a center portion of the electrode body 120 in a width direction X of the sealed battery 100 (hereinafter, also simply referred to as the “width direction X”). In addition, a positive electrode connecting portion 124 where a positive electrode current collector (a positive electrode exposed portion) in which a mixture layer is not formed is wound in multiple layers is formed in one side edge portion of the electrode body 120 in the width direction X. A positive electrode terminal 130 is connected to the positive electrode connecting portion 124 to form a positive electrode-connected location 132. In addition, a negative electrode connecting portion 126 where a negative electrode current collector (a negative electrode exposed portion) in which a mixture layer is not formed is wound in multiple layers is formed in another side edge portion of the electrode body 120. A negative electrode terminal 140 is connected to the negative electrode connecting portion 126 to form a negative electrode-connected location 142. Examples of sealed batteries structured in this manner are described in WO 2012/77194, Japanese Patent Application Publication No. 2010-282849, Japanese Patent Application Publication No. 2003-187781, and Japanese Patent Application Publication No. 2011-243527.

In the sealed battery 100 structured as described above, the electrode body 120 may generate heat during charge and discharge. When the temperature of the electrode body 120 becomes too high due to the generation of heat, the insulating separator interposed between the positive electrode and the negative electrode contracts, which may result in the positive electrode and the negative electrode coming into contact with each other at a side edge portion of the core portion 122 and causing an internal short circuit.

Japanese Patent Application Publication No. 2011-243527 discloses an example of a countermeasure to an internal short circuit due to such a contraction of a separator. The literature focuses on the fact that the contraction of the separator proceeds faster on the side of the positive electrode than on the side of the negative electrode. In addition, based on the idea that heat is more likely to build up and temperature is more likely to rise on the side of the positive electrode than on the side of the negative electrode with respect to such phenomena, a position where the electrode body is housed is shifted towards the side of the negative electrode. Specifically, in the literature, the wound electrode body is positioned in a battery case such that a distance A from an edge on a uncoated portion side of a positive electrode mixture layer to an inner wall of the battery case is longer than a distance B from an edge on an opposite side of the positive electrode mixture layer to the inner wall of the battery case (A>B). Accordingly, since a gap between the battery case and the wound electrode body on the positive electrode side can be widened, gas (heat) released into the gap can be smoothly discharged to the outside.

### SUMMARY

However, against a backdrop of growing demands toward safety with respect to sealed batteries, there is a need to develop a technique that enables an internal short circuit due to a contraction of a separator to be prevented more preferably than conventional techniques.

The present disclosure has been made in consideration of such circumstances and a main object thereof is to provide a technique that enables a contraction of a separator due to generation of heat by an electrode body to be appropriately suppressed and an internal short circuit due to the contraction of the separator to be preferably prevented.

By carrying out various studies in order to achieve the object described above, the present inventors found that the phenomenon in which a separator more readily contracts on a positive electrode side than on a negative electrode side has causes other than the positive electrode side being susceptible to heat buildup. The findings made by the present inventors will now be described with reference to FIG. 9. When the electrode body 120 generates heat during charge and discharge of the sealed battery 100, an amount of generated heat increases, particularly in the three locations of a center of the core portion 122, the positive electrode-connected location 132, and the negative electrode-connected location 142. This is because charge and discharge takes place particularly actively at the center of the core portion 122 while connecting portions in the positive electrode-connected location 132 and the negative electrode-connected location 142 have high resistance. In addition, among these three heat generation areas, there is a tendency that the amount of generated heat particularly increases in the two locations of the center of the core portion 122 and the positive electrode-connected location 132. In this case, since a region in the vicinity of a positive electrode side edge portion 122a (a side edge portion on the positive electrode side of the core portion 122) is positioned between the center of the core portion 122 and the positive electrode-connected location 132, heat is likely to concentrate and a localized temperature rise is likely to occur in this region. The present inventors considered the localized temperature rise due to the concentration of heat in the vicinity of the positive electrode side edge portion 122a to be the cause of the greater contraction of the separator on the positive electrode side.

Based on the observations described above, the present inventors considered that by bringing a formation position of the core portion of the electrode body into close proximity of the negative electrode terminal while distancing the positive electrode side edge portion of the core portion from the positive electrode-connected location, since concentration of heat in a vicinity of the positive electrode side edge portion can be alleviated and a localized temperature rise can be suppressed, an internal short circuit due to a contraction of the separator can be prevented more preferably than with conventional techniques. Exhaustive experiments subsequently carried out culminated in creating the sealed battery disclosed herein.

The sealed battery disclosed herein was devised on the basis of the findings described above, and includes: an electrode body in which a sheet-shaped positive electrode and a sheet-shaped negative electrode are laminated via a separator; a flat square case which houses the electrode body; a positive electrode terminal, which is an electrode terminal including aluminum or an aluminum alloy, which is electrically connected to the positive electrode inside the case and of which a part is exposed to the outside of the case; and a negative electrode terminal, which is an electrode terminal including copper or a copper alloy, which is electrically connected to the negative electrode inside the case and of which a part is exposed to the outside of the case. The positive electrode of the sealed battery has a foil-like positive electrode current collector including aluminum or an aluminum alloy and a positive electrode mixture layer formed on a surface of the positive electrode current collector, and a positive electrode exposed portion in which the positive electrode mixture layer is not formed and the positive electrode current collector is exposed is formed in one side edge portion in a width direction. On the other hand, the negative electrode has a foil-like negative electrode current collector including copper or a copper alloy and a negative electrode mixture layer formed on a surface of the negative electrode current collector, and a negative electrode exposed portion in which the negative electrode mixture layer is not formed and the negative electrode current collector is exposed is formed in another side edge portion in the width direction. In addition, a core portion in which the positive electrode mixture layer and the negative electrode mixture layer oppose each other is formed in a center portion in the width direction of the electrode body, a positive electrode connecting portion on which the positive electrode exposed portion is laminated is formed on the one side edge portion in the width direction, and a negative electrode connecting portion on which the negative electrode exposed portion is laminated is formed on the other side edge portion in the width direction. Furthermore, in the sealed battery, the positive electrode connecting portion and the positive electrode terminal are connected at a positive electrode-connected location, and the negative electrode connecting portion and the negative electrode terminal are connected at a negative electrode-connected location.

Moreover, in the sealed battery disclosed herein, when a distance L1 is a shortest distance between a positive electrode side edge portion that is a side edge portion of the core portion on a side of the positive electrode connecting portion and a side edge portion on a core portion side of the positive electrode-connected location. A distance L2 is a shortest distance between a negative electrode side edge portion that is a side edge portion of the core portion on a side of the negative electrode connecting portion and a side edge portion on the core portion side of the negative electrode-connected location. In addition, the core portion is formed such that the distance L1 and the distance L2 satisfy the following expression (1).

1<L1/L2<1.8 (1)

By adjusting a formation position of the core portion so as to satisfy the mathematical expression (1) described above, an occurrence of a localized temperature rise in a specific region can be suppressed and an internal short circuit due to a contraction of the separator can be preferably prevented. Specifically, by bringing the formation position of the core portion into close proximity of the negative electrode terminal and making the shortest distance (the distance L1) from the positive electrode side edge portion to the side edge portion on the core portion side of the positive electrode-connected location longer than the shortest distance (the distance L2) from the negative electrode side edge portion to the side edge portion on the core portion side of the negative electrode-connected location (1<L1/L2), a localized temperature rise in the vicinity of the positive electrode side edge portion can be appropriately suppressed. On the other hand, bringing the core portion too close to the negative electrode terminal may reverse temperatures of the positive electrode side edge portion and the negative electrode side edge portion and may cause a localized temperature to rise in the vicinity of the negative electrode side edge portion. Therefore, in the sealed battery disclosed herein, an upper limit of L1/L2 is set lower than 1.8.

In addition, in a preferable mode of the sealed battery disclosed herein, a difference between the distance L1 and the distance L2 (L1−L2) is 4.3 mm or less.

Accordingly, an occurrence of a localized temperature rise in the vicinity of the negative electrode side edge portion can be preferably prevented.

Furthermore, as another aspect of the technique disclosed herein, an assembled battery including a plurality of unit cells is provided. In the assembled battery disclosed herein, each of the plurality of unit cells is the sealed battery according to any of the modes described above, and each unit cell is arranged so that a positive electrode terminal and a negative electrode terminal are in close proximity with each other between adjacent unit cells and, at the same time, broad width surfaces of flat square cases oppose each other. In addition, the positive electrode terminal and the negative electrode terminal are electrically connected to each other via a busbar between adjacent unit cells, and a constraining member is provided which constrains each unit cell in an arrangement direction of the unit cells. Furthermore, in the assembled battery, the positive electrode side edge portion of each unit cell is arranged closer to a center side in the width direction than the negative electrode side edge portion of the cell.

In the sealed battery according to the mode described above, the negative electrode side edge portion of the core portion is in close proximity with the negative electrode terminal and the positive electrode connecting portion is distanced from the positive electrode terminal. Using such sealed batteries as unit cells and electrically arranging the cells in series causes the positive electrode side edge portion of each unit cell to be arranged closer to the center side in the width direction than the negative electrode side edge portion. Constraining each unit cell in this state makes it easier for a constraint load to act in the vicinity of the positive electrode side edge portion and enables a contraction of the separator in the vicinity of the positive electrode side edge portion to be physically suppressed.

In addition, in a preferable mode of the assembled battery disclosed herein, a plate-shaped spacer is arranged between the respective unit cells.

Accordingly, since a uniform constraint load can be applied to each unit cell, a contraction of the separator in the vicinity of the positive electrode side edge portion can be more preferably suppressed.

Furthermore, in a preferable mode of the assembled battery disclosed herein, a length in the width direction of the spacer is longer than a length in the width direction of the core portion.

Accordingly, since a constraint load can be applied to both side edge portions of the core portion, a contraction of the separator can be suppressed even more preferably.

### BRIEF DESCRIPTION OF THE DRAWINGS

FIG. 1 is a perspective view schematically showing a sealed battery according to an embodiment of the present disclosure;

FIG. 2 is a front view schematically showing an internal structure of the sealed battery according to an embodiment of the present disclosure;

FIG. 3 is a perspective view schematically showing an electrode body according to an embodiment of the present disclosure;

FIG. 4 is a perspective view schematically showing an assembled battery using the sealed battery according to an embodiment of the present disclosure;

FIG. 5 is a plan view schematically showing the assembled battery using the sealed battery according to an embodiment of the present disclosure;

FIG. 6 is a graph showing a result of a temperature measurement test with respect to samples 1 to 6;

FIG. 7 is a graph showing a result of a temperature measurement test with respect to samples 1 to 6;

FIG. 8 is a plan view for illustrating a constraining instrument used in a withstand voltage test; and

FIG. 9 is a front view schematically showing an internal structure of a conventional sealed battery.

### DETAILED DESCRIPTION

Hereinafter, a lithium-ion secondary battery will be described as an example of a sealed battery according to an embodiment of the present disclosure. It should be noted that a structure of the sealed battery disclosed herein is not limited to a lithium-ion secondary battery and the sealed battery disclosed herein can be applied to various secondary batteries (for example, a nickel-hydrogen battery).

In addition, in the following drawings, members and portions that produce the same effects will be described using the same reference characters. It should be noted that dimensional relationships (length, width, thickness, and the like) shown in the respective drawings do not reflect actual dimensional relationships. Furthermore, matters required to carry out the present disclosure (for example, a composition, a manufacturing process, and the like of an electrolyte) other than those specifically described in the present specification may be comprehended as design matters for a person with ordinary skill in the art based on prior art in a relevant technical field.

### 1. Sealed Battery

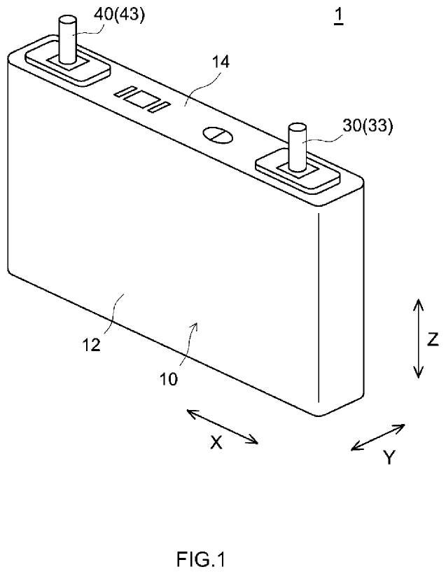

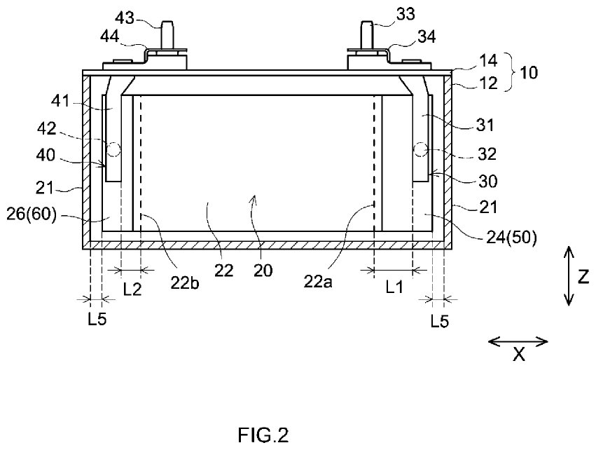

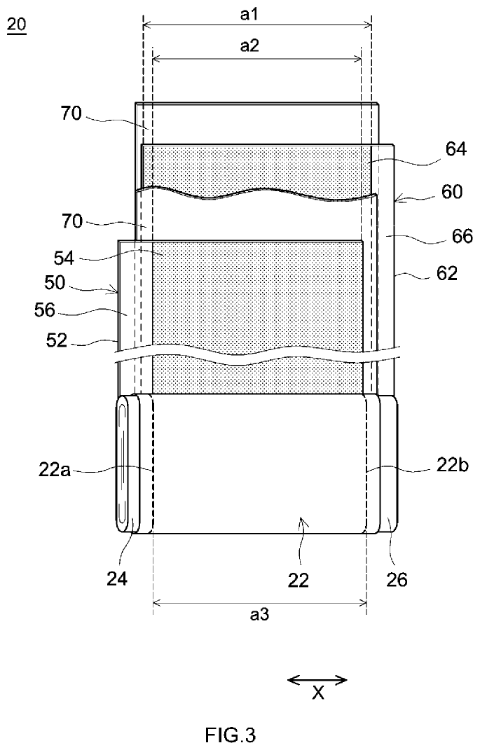

FIG. 1 is a perspective view schematically showing a sealed battery according to the present embodiment. FIG. 2 is a front view schematically showing an internal structure of the sealed battery according to the present embodiment. In addition, FIG. 3 is a perspective view schematically showing an electrode body according to the present embodiment. It should be noted that, in the respective drawings of the present specification, reference character X indicates a “width direction (of the sealed battery)”, reference character Y indicates a “thickness direction (of the sealed battery)”, and reference character Z indicates a “height direction (of the sealed battery)”.

### (1) Case

As shown in FIG. 1, the sealed battery 1 according to the present embodiment includes a flat square case 10. The case 10 includes a so-called square case main body 12 formed with a bottom and in a rectangular parallelopiped shape, an opening (not shown) formed in an upper part of the case main body 12, and a lid 14 which closes the opening. The case 10 is favorably constructed mainly using a light-weight and high-strength metallic material such as aluminum.

As shown in FIG. 2, in the sealed battery 1 according to the present embodiment, an electrode body 20 is housed inside the case 10. At this point, a housing position of the electrode body 20 is favorably set such that a distance L5 between an inner wall of the case 10 and a side edge portion 21 of the electrode body 20 is approximately the same on a positive electrode side and a negative electrode side. Although details will be given later, with the sealed battery 1 according to the present embodiment, a contraction of a separator due to a localized temperature rise is suppressed without changing the housing position of the electrode body 20. Therefore, significant design changes in electrode terminals 30 and 40 and external devices caused by a change in the housing position of the electrode body 20 do not occur and an internal short circuit due to a contraction of the separator can be accommodated at low cost. It should be noted that being “approximately the same on the positive electrode side and the negative electrode side” as described above takes a manufacturing error into consideration and means that, for example, when the manufacturing error is within a range of ±0.5 mm, a difference in the distance L5 between the positive electrode side and the negative electrode side is allowed.

In addition, although not shown, a nonaqueous electrolyte is housed in addition to the electrode body 20 inside the case 10. Materials that may be used in a general lithium-ion secondary battery can be used as the nonaqueous electrolyte without particular restrictions, and since the nonaqueous electrolyte does not characterize the present disclosure, a description thereof will be omitted.

### (2) Electrode Body

The electrode body 20 is a power generating element including a sheet-shaped positive electrode and a sheet-shaped negative electrode. In the present embodiment, as the electrode body 20, a wound electrode body such as that shown in FIG. 3 is used. The wound electrode body 20 is fabricated by forming a laminate by laminating a positive electrode 50 and a negative electrode 60 via an insulating separator 70 and subsequently winding the laminate in multiple layers.

### (a) Positive Electrode

The positive electrode 50 is a sheet-shaped electrode having a foil-like positive electrode current collector 52 and a positive electrode mixture layer 54 formed on a surface of the positive electrode current collector 52. In the positive electrode 50, a positive electrode exposed portion 56 in which the positive electrode mixture layer 54 is not formed and the positive electrode current collector 52 is exposed is formed in one side edge portion in the width direction X.

For the positive electrode current collector 52, aluminum or an aluminum alloy, which is an inexpensive material with favorable conductivity and which is a material that does not melt due to potential during charge and discharge, is used. It should be noted that the positive electrode current collector 52 may include metallic materials other than the aluminum or the aluminum alloy described above.

The positive electrode mixture layer 54 is a layer that contains a positive electrode active material. Since various compounds conventionally used in batteries of this type can be used as the positive electrode active material in the present embodiment, a detailed description of the positive electrode active material will be omitted. Preferable examples of the positive electrode active material include composite oxides with a layered structure as typified by LiCoO₂, LiNiO₂, and LiNiₓCo_{y}Mn_{(1-x-y)}O₂ (where 0<x<1, 0<y<1, 0<x+y<1). Other examples include composite oxides with a spinel structure as typified by Li₂NiMn₃O₈, LiMn₂O₄, and Li₁₊ₓMn_{2-y}M_{y}O₄ (where M is absent or denotes one or more metal elements selected from the group consisting of Al, Mg, Co, Fe, Ni, and Zn, 0≤x<1, 0≤y<2) and a composite compound with an olivine structure such as LiFePO₄.

It should be noted that, in a similar manner to the positive electrode mixture layer of conventional batteries of this type, the positive electrode mixture layer 54 can include arbitrary components other than the positive electrode active material as necessary. Examples of the arbitrary components include a conductive material and a binder. As the conductive material, carbon black such as acetylene black and other carbon materials (such as graphite and carbon nanotubes) may be preferably used. As the binder, a fluorine-based binder such as polyvinylidene fluoride (PVDF) or polytetrafluoroethylene (PTFE) or a rubber-based binder such as styrene butadiene rubber (SBR) can be used.

### (b) Negative Electrode

The negative electrode 60 is a sheet-shaped electrode having a foil-like negative electrode current collector 62 and a negative electrode mixture layer 64 formed on a surface of the negative electrode current collector 62. In a similar manner to the positive electrode 50 described above, the negative electrode 60 is also provided with a region where the current collector is exposed. Specifically, in the negative electrode 60, a negative electrode exposed portion 66 in which the negative electrode mixture layer 64 is not formed and the negative electrode current collector 62 is exposed is formed in another side edge portion in the width direction X.

For the negative electrode current collector 62, copper which is an inexpensive material with favorable conductivity and which is a material that does not melt due to potential during charge and discharge or a copper alloy is used. It should be noted that the negative electrode current collector 62 may include metallic materials other than the copper or the copper alloy described above.

The negative electrode mixture layer 64 is a layer that contains a negative electrode active material. Since various compounds conventionally used in batteries of this type can be used as the negative electrode active material in the present embodiment, a detailed description of the negative electrode active material will be omitted. Preferable examples of the negative electrode active material include carbon materials such as graphite, mesocarbon microbeads, and carbon black (acetylene black, Ketjen black, and the like).

It should be noted that, in a similar manner to the negative electrode mixture layer of conventional batteries of this type, the negative electrode mixture layer 64 can include arbitrary components other than the negative electrode active material. For example, the negative electrode mixture layer 64 may include a conductive material and a binder in a similar manner to the positive electrode mixture layer 54. As the binder, a fluorine-based binder such as PVDF or PTFE or a rubber-based binder such as SBR can be preferably used.

### (c) Separator

The separator 70 is an insulating sheet arranged so as to be interposed between the positive electrode 50 and the negative electrode 60. As the separator 70, an insulating sheet is used in which minute holes that allow a charge carrier (for example, lithium ions) to pass through are formed in plurality. As a material of the separator 70, materials similar to those used in a general lithium-ion secondary battery can be used. Examples of the material of the separator 70 include a porous polyolefin-based resin. In addition, a heat resistant layer (HRL layer) may be formed on a surface of the separator 70. Accordingly, heat resistance of the separator 70 can be improved and a contraction due to heat can be more preferably suppressed.

### (d) Wound Structure

The wound electrode body 20 according to the present embodiment is fabricated by forming a laminate by laminating the positive electrode 50 and the negative electrode 60 via the separator 70 so that the positive electrode exposed portion 56 and the negative electrode exposed portion 66 respectively protrude from both sides in the width direction X and subsequently winding the laminate. A core portion 22 in which the positive electrode mixture layer 54 and the negative electrode mixture layer 64 oppose each other is formed in a center portion in the width direction X of the wound electrode body 20. In addition, a positive electrode connecting portion 24 in which the positive electrode exposed portion 56 is wound in multiple layers is formed in one side edge portion in the width direction X of the wound electrode body 20. Furthermore, a negative electrode connecting portion 26 in which the negative electrode exposed portion 66 is wound in multiple layers is formed in another side edge portion in the width direction X of the wound electrode body 20.

In addition, in the present specification, a side edge portion of the core portion 22 on the side of the positive electrode connecting portion 24 will be referred to as a “positive electrode side edge portion 22a” (refer to FIG. 2). And, a side edge portion of the core portion 22 on the side of the negative electrode connecting portion 26 will be referred to as a “negative electrode side edge portion 22b”. In this example, as shown in FIG. 3, a width a1 of the negative electrode mixture layer 64 is slightly wider than a width a2 of the positive electrode mixture layer 54 (a1>a2). Therefore, a width a3 of the core portion 22 in which the positive electrode mixture layer 54 and the negative electrode mixture layer 64 oppose each other is narrower than the width a1 of the negative electrode mixture layer 64. In other words, the positive electrode side edge portion 22a and the negative electrode side edge portion 22b which are side edge portions of the core portion 22 are formed closer to a center side in the width direction X than both side edge portions of the negative electrode mixture layer 64.

### (3) Electrode Terminal

As shown in FIG. 1, the sealed battery 1 according to the present embodiment includes a positive electrode terminal 30 and a negative electrode terminal 40. The electrode body 20 housed inside the case 10 is electrically connected to an external device such as a motor of a vehicle via the positive electrode terminal 30 and the negative electrode terminal 40.

As shown in FIG. 2, the positive electrode terminal 30 is electrically connected to the positive electrode 50 of the wound electrode body 20 inside the case 10 and a part of the positive electrode terminal 30 is exposed to the outside of the case 10. Specifically, the positive electrode terminal 30 includes a positive electrode current-collecting member 31 which is a conductive plate-shaped member extending in the height direction Z, a connecting bolt 33 exposed to the outside of the case 10, and an external connecting member 34 which connects the positive electrode current-collecting member 31 and the connecting bolt 33 to each other. In addition, the positive electrode current-collecting member 31 of the positive electrode terminal 30 and the positive electrode connecting portion 24 of the wound electrode body 20 are connected by ultrasonic welding, resistance welding, laser welding, or the like. A positive electrode-connected location 32 is formed in a connection portion of the positive electrode connecting portion 24 and the positive electrode current-collecting member 31 (the positive electrode terminal 30). From the perspectives of being inexpensive and having favorable conductivity, the positive electrode terminal 30 is constituted by aluminum, an aluminum alloy, or the like.

On the other hand, the negative electrode terminal 40 is electrically connected to the negative electrode 60 of the wound electrode body 20 inside the case 10 and a part of the negative electrode terminal 40 is exposed to the outside of the case 10. The negative electrode terminal 40 according to the present embodiment is configured in a similar manner to the positive electrode terminal 30 described above. Specifically, the negative electrode terminal 40 includes a negative electrode current-collecting member 41 which is a conductive plate-shaped member extending in the height direction Z, a connecting bolt 43 exposed to the outside of the case 10, and an external connecting member 44 which connects the negative electrode current-collecting member 41 and the connecting bolt 43 to each other. In addition, the negative electrode current-collecting member 41 of the negative electrode terminal 40 and the negative electrode connecting portion 26 of the wound electrode body 20 are connected by resistance welding, ultrasonic welding, laser welding, or the like. A negative electrode-connected location 42 is formed in a connection portion of the negative electrode connecting portion 26 and the negative electrode current-collecting member 41 (the negative electrode terminal 40). The negative electrode terminal 40 is constituted by copper, a copper alloy, or the like.

### (4) Formation Position of Core Portion

In the sealed battery 1 according to the present embodiment, the core portion 22 is formed so as to satisfy a mathematical expression (1) below. Here, “a distance L1” described in the mathematical expression (1) is a shortest distance between the positive electrode side edge portion 22a and a side edge portion on a side of the core portion 22 of the positive electrode-connected location 32. And, “a distance L2” is a shortest distance between the negative electrode side edge portion 22b and a side edge portion on the side of the core portion 22 of the negative electrode-connected location 42. According to abobe configuration, a localized temperature rise due to concentration of heat in a specific region of the wound electrode body 20 can be suppressed and an occurrence of an internal short circuit due to a contraction of the separator can be preferably prevented. Hereinafter, a description will be given in concrete terms.

1<L1/L2<1.8 (1)

First, the core portion 22 according to the present embodiment is formed such that the distance L1 is longer than the distance L2 (L1/L2>1). That is, the shortest distance between the positive electrode side edge portion 22a and the side edge portion on the side of the core portion 22 of the positive electrode-connected location 32 is longer than the shortest distance between the negative electrode side edge portion 22b and the side edge portion on the side of the core portion 22 of the negative electrode-connected location 42. By adjusting the formation position of the core portion 22 so that the core portion 22 and the negative electrode-connected location 42 come into close proximity with each other and the positive electrode side edge portion 22a is distanced from the positive electrode-connected location 32, heat generated at a center of the core portion 22 and heat generated at the positive electrode-connected location 32 can be prevented from concentrating in a vicinity of the positive electrode side edge portion 22a. Accordingly, a localized temperature rise in the vicinity of the positive electrode side edge portion 22a can be suppressed and an internal short circuit in accordance with a contraction of the separator in the region can be preferably prevented.

On the other hand, bringing the core portion 22 too close to the negative electrode terminal 40 causes heat generated at the center of the core portion 22 and heat generated at the negative electrode-connected location 42 to concentrate in a vicinity of the negative electrode side edge portion 22b. In this case, a reversal of temperatures of the positive electrode side edge portion 22a and the negative electrode side edge portion 22b may occur and a localized temperature rise due to heat concentration may occur in the vicinity of the negative electrode side edge portion 22b. Therefore, in the sealed battery 1 according to the present embodiment, an upper limit of L1/L2 described above is set lower than 1.8.

As described above, by having the distance L1 and the distance L2 satisfy the mathematical expression (1) above, a localized temperature rise due to heat concentration in a specific region of the wound electrode body 20 can be suppressed. Therefore, according to the present embodiment, a contraction of the separator due to generation of heat by the electrode body can be appropriately suppressed and an internal short circuit due to the contraction of the separator can be preferably prevented.

In addition, from the perspective of more preferably suppressing heat concentration in the vicinity of the positive electrode side edge portion 22a, a lower limit of L1/L2 described above is favorably 1.05 or higher, more favorably 1.1 or higher, even more favorably 1.15 or higher, and particularly favorably 1.2 or higher. Furthermore, from the perspective of more preferably suppressing heat concentration in the vicinity of the negative electrode side edge portion 22b, the upper limit of L1/L2 described above is favorably 1.7 or lower, more favorably 1.64 or lower, even more favorably 1.5 or lower, and particularly favorably 1.46 or lower. Typically, by configuring the sealed battery 1 so that L1/L2 described above equals 1.21, respective temperatures of the vicinity of the positive electrode side edge portion 22a and the vicinity of the negative electrode side edge portion 22b can be adjusted to similar levels and a localized temperature rise in a specific region can be more preferably prevented.

Furthermore, as described above, in the present embodiment, L1/L2 is adjusted by changing a formation position of the core portion 22. While L1/L2 can also be adjusted by reducing the width a3 of the core portion 22, since this widens areas of the positive electrode connecting portion 24 and the negative electrode connecting portion 26 which do not contribute to charge and discharge. Therefore, it is more favorable to adjust L1/L2 by changing the formation position of the core portion 22 while maintaining dimensions of the core portion 22.

In addition, although a specific dimensional difference between the distance L1 and the distance L2 (L1−L2) is changed as appropriate in accordance with a size or the like of the sealed battery 1 and is therefore not particularly limited. An example of the dimensional difference (L1−L2) is favorably 0.1 mm or more, more favorably 0.5 mm or more, even more favorably 1 mm or more, and particularly favorably 1.5 mm or more. Accordingly, heat concentration in the vicinity of the positive electrode side edge portion 22a can be preferably suppressed. On the other hand, an upper limit of L1−L2 is favorably 4.3 mm or less, more favorably 4.0 mm or less, even more favorably 3.3 mm or less, and particularly favorably 2 mm or less. Accordingly, heat concentration in the vicinity of the negative electrode side edge portion 22b can be preferably suppressed. Typically, by configuring the sealed battery 1 so that L1−L2 equals 1.7 mm, respective temperatures of the vicinity of the positive electrode side edge portion 22a and the vicinity of the negative electrode side edge portion 22b can be adjusted to similar levels and a localized temperature rise in a specific region can be more preferably prevented.

Furthermore, as described above, in the sealed battery 1 according to the present embodiment, aluminum-based materials are used in the positive electrode current collector 52 and the positive electrode terminal 30 and copper-based materials are used in the negative electrode current collector 62 and the negative electrode terminal 40. However, combining the materials of the current collectors and the electrode terminals as described above causes an amount of generated heat at the positive electrode-connected location 32 to exceed an amount of generated heat at the negative electrode-connected location 42 and increases the likelihood of an occurrence of heat concentration in the vicinity of the positive electrode side edge portion 22a. By comparison, according to the present embodiment, since heat concentration in the vicinity of the positive electrode side edge portion 22a can be suppressed, even when using materials combined as described above, a localized temperature rise in the vicinity of the positive electrode side edge portion 22a can be suppressed.

It should be noted that the technique disclosed herein can be particularly favorably applied to sealed batteries with a maximum current value of 100 A or larger. For example, while the maximum current value of a general lithium-ion secondary battery is around 55 A, in response to recent demands for higher performance, improvements are being introduced in order to increase the maximum current values of batteries to 100 A or larger (more preferably, 150 A or larger). However, with a sealed battery that accommodates such larger currents, since the amount of heat generated at the positive electrode-connected location 32 further increases, the likelihood of an occurrence of a localized temperature rise in the vicinity of the positive electrode side edge portion 22a also increases. By comparison, according to the technique disclosed herein, a heat concentration in the vicinity of the positive electrode side edge portion 22a can be appropriately suppressed. Thus, a contraction of the separator can be prevented even in the case of a sealed battery with a maximum current value of 100 A or larger. In the point described above, the technique disclosed herein contributions can be made toward increasing current in a sealed battery.

### 2. Assembled Battery

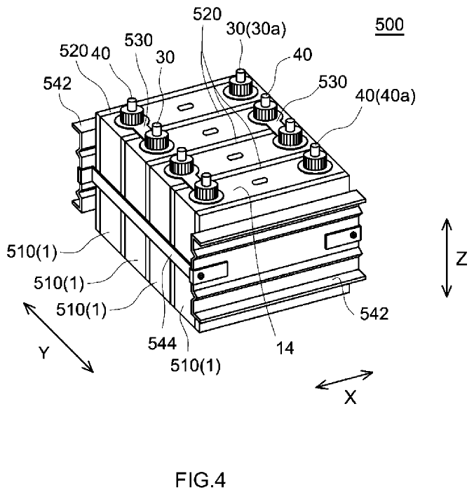

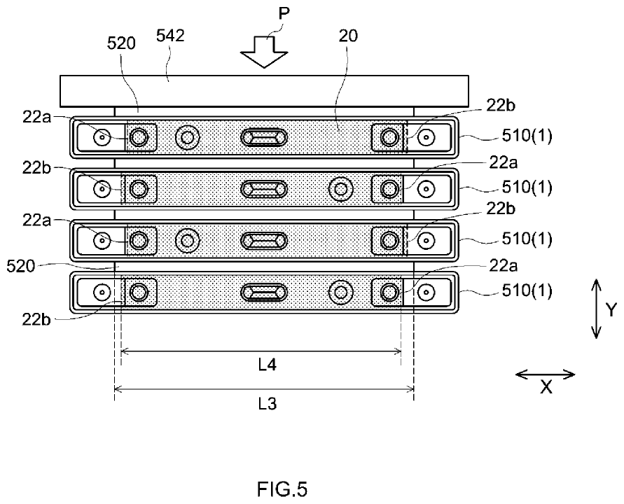

Next, the sealed battery according to the present embodiment can be particularly favorably used as a unit cell that constitutes an assembled battery. Hereinafter, an assembled battery using the sealed battery according to the present embodiment as a unit cell will be described. FIG. 4 is a perspective view schematically showing an assembled battery using the sealed battery according to the present embodiment. In addition, FIG. 5 is a plan view schematically showing the assembled battery using the sealed battery according to the present embodiment.

An assembled battery 500 shown in FIG. 4 includes a plurality of unit cells 510. And the sealed battery 1 according to the present embodiment is used as each unit cell 510. In addition, in the assembled battery 500, the positive electrode terminal 30 and the negative electrode terminal 40 are in close proximity to each other between adjacent unit cells 510 and, at the same time, the respective unit cells 510 are arranged so that broad width surfaces of the cases 10 oppose each other. Furthermore, the positive electrode terminal 30 and the negative electrode terminal 40 in close proximity to each other are electrically connected by a busbar 530 which is a plate-shaped conductive member. In this case, the positive electrode terminal 30 of the unit cell 510 arranged at one end in an arrangement direction (in other words, the thickness direction Y of the case) becomes a positive electrode external terminal 30a to be connected to an external device without being connected to another unit cell 510. In addition, the negative electrode terminal 40 of the unit cell 510 arranged at another end in the arrangement direction becomes a negative electrode external terminal 40a to be connected to an external device without being connected to another unit cell 510.

In addition, the assembled battery 500 includes a constraining member that constrains each unit cell 510 with a prescribed constraint load in the arrangement direction. The constraining member includes a pair of end plates 542 and a clamping beam member 544. Specifically, the pair of end plates 542 is respectively arranged on outermost sides in the arrangement direction, and by attaching the clamping beam member 544 which extends in the arrangement direction so as to bridge the pair of end plates 542, each unit cells 510 are constrained in the arrangement direction.

As described earlier, in the sealed battery 1 according to the present embodiment, the core portion 22 is formed such that the distance L1 which is the shortest distance between the positive electrode side edge portion 22a and the positive electrode terminal 30 is longer than the distance L2 which is the shortest distance between the negative electrode side edge portion 22b and the negative electrode terminal 40 (1<L1/L2) (refer to FIG. 2). Constructing the assembled battery 500 using the sealed battery 1 configured in this manner causes the positive electrode side edge portion 22a of each unit cell 510 to be arranged closer to the center side in the width direction X than the negative electrode side edge portion 22b as shown in FIG. 5 despite the respective unit cells 510 being arranged so that outer side surfaces of the cases 10 are aligned with each other. Constraining each unit cell 510 in this state makes it easier for a constraint load P to act in the vicinity of the positive electrode side edge portion 22a and enables a contraction of the separator in the vicinity of the positive electrode side edge portion 22a to be physically suppressed. When the assembled battery 500 is constructed using the sealed battery 1 according to the present embodiment as described above, since a contraction of a separator can be suppressed by a physical action based on constraint pressure in addition to suppressing a localized temperature rise, an occurrence of an internal short circuit due to a contraction of the separator can be more preferably prevented.

In addition, in the present embodiment, a spacer 520 is arranged between the respective unit cells 510. Accordingly, since the constraint load P can be appropriately applied to each of the plurality of unit cells 510, an effect of suppressing a contraction of the separator due to a physical effect can be more appropriately exhibited. Furthermore, from the perspective of more preferably producing the physical effect of suppressing a contraction due to the constraint load P, a length L3 of the spacer 520 in the width direction X is more favorably set longer than a length L4 of the core portion 22 in the width direction X.

While an embodiment of the present disclosure has been described above, the embodiment described above is not intended to limit the present disclosure and various configurations may be modified.

For example, while a wound electrode body is used as an electrode body in the embodiment described above, a structure of the electrode body is not particularly limited. Other examples of the electrode body include a laminated electrode body. The laminated electrode body is fabricated by alternately laminating prescribed numbers of sheet-shaped positive electrodes and sheet-shaped negative electrode while interposing separators. A core portion in which mixture layers of the positive electrodes and the negative electrodes oppose each other is formed in a center portion in the width direction of the laminated electrode body, and a positive electrode connecting portion on which a positive electrode exposed portion is laminated is formed in one side edge portion in the width direction. In addition, a negative electrode connecting portion on which a negative electrode exposed portion is laminated is formed in another side edge portion in the width direction. Even when using such a laminated electrode body, by forming the core portion such that the distance L1 and the distance L2 satisfy the mathematical expression (1) described above, an occurrence of a localized temperature rise due to heat concentration in a specific region can be suppressed and an internal short circuit due to a contraction of separators can be preferably prevented.

### Text Example

While a test relating to the present disclosure will be described below, it is to be understood that the following description is not intended to limit the present disclosure.

### 1. Fabrication of Samples

### (1) Sample 1

In sample 1, as a positive electrode, an electrode sheet was fabricated by forming, on both sides of a positive electrode current collector (made of aluminum), a positive electrode mixture layer in which a positive electrode active material (LiNi_{1/3}Co_{1/3}Mn_{1/3}O₂), a conductive material (acetylene black), and a binder (polyvinylidene fluoride) were mixed at a mass ratio of 94:3:3. On the other hand, as a negative electrode, an electrode sheet was fabricated by forming, on both sides of a negative electrode current collector (made of copper), a negative electrode mixture layer in which a negative electrode active material (graphite), a thickener (carboxymethyl cellulose), and a binder (styrene butadiene rubber) were mixed at a mass ratio of 98:1:1.

Next, a laminate was formed in which the positive electrode and the negative electrode were laminated via a separator made of polyethylene, and a wound electrode body was fabricated by winding the laminate. At this point, in the present example, formation regions of the electrode mixture layers of the positive and negative electrodes and winding positions were adjusted so that a center in a width direction of the wound electrode body was consistent with a center in the width direction of a core portion. Subsequently, a positive electrode terminal (made of aluminum) was connected to a positive electrode connecting portion of the wound electrode body by ultrasonic welding, and a negative electrode terminal (made of copper) was connected to a negative electrode connecting portion of the wound electrode body by resistance welding. At this point, the shortest distance (the distance L1) between the positive electrode side edge portion and the positive electrode terminal and the shortest distance (the distance L2) between the negative electrode side edge portion and the negative electrode terminal were both 8.85 mm. In addition, after housing the wound electrode body in a case, the case was filled with a nonaqueous electrolyte, and a test lithium-ion secondary battery (sample 1) was fabricated by tightly sealing the case.

### (2) Sample 2

In sample 2, a test battery was fabricated under the same conditions as sample 1 with the exception of bringing the formation position of the core portion of the wound electrode body closer to a positive electrode terminal side by 0.85 mm. In sample 2, the distance L1 was 8.00 mm and the distance L2 was 9.70 mm.

### (3) Samples 3 to 6

In samples 3 to 6, test batteries were fabricated under the same conditions as sample 1 with the exception of bringing the formation position of the core portion of the wound electrode body closer to a negative electrode terminal side by prescribed distances. The distance L1 and the distance L2 in samples 3 to 6 were as shown in Table 1 to be described later.

### 2. Evaluation Tests

### (1) Temperature Measurement Test

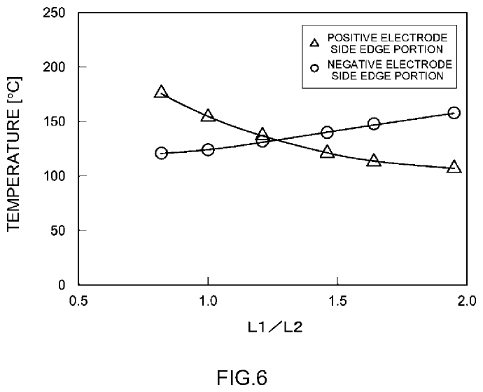

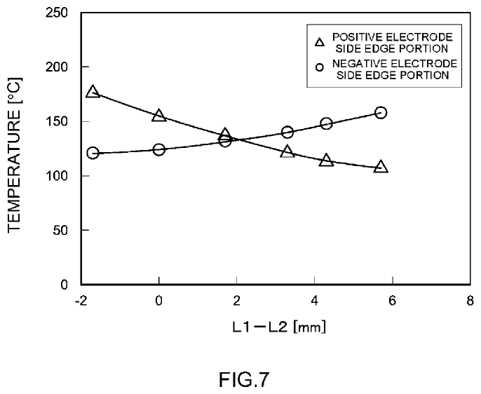

In the present test, a temperature (a maximum temperature) of the inside of a battery during an overcharge was measured by performing an overcharge test involving inserting thermocouples inside each sample. The thermocouples were arranged at two locations, namely, a vicinity of the positive electrode side edge portion and a vicinity of the negative electrode side edge portion. In the overcharge test, in a temperature environment of 60° C., a constant current charge (CC charge) was performed at a large current charge rate of 190 A from a state of charge (SOC) of 15%. The charge was stopped once voltage between the positive and negative electrode terminals reached 10 V, at which point the maximum temperature (° C.) of the positive electrode side edge portion and the maximum temperature (° C.) of the negative electrode side edge portion were measured. Measurement results are shown in Table 1 and FIGS. 6 and 7.

TABLE 1

| | | | | | Positive electrode | Negative electrode |
|---|---|---|---|---|---|---|
| | | | | | side edge portion | side edge portion |
| | Distance L1 | Distance L2 | | | maximum | maximum |
| | (mm) | (mm) | L1 − L2 | L1/L2 | temperature | temperature |
| Sample 1 | 8.85 | 8.85 | 0.00 | 1.00 | 154 | 124 |
| Sample 2 | 8.00 | 9.70 | −1.70 | 0.82 | 176 | 121 |
| Sample 3 | 9.70 | 8.00 | 1.70 | 1.21 | 137 | 132 |
| Sample 4 | 10.50 | 7.20 | 3.30 | 1.46 | 121 | 140 |
| Sample 5 | 11.00 | 6.70 | 4.30 | 1.64 | 113 | 148 |
| Sample 6 | 11.70 | 6.00 | 5.70 | 1.95 | 107 | 158 |

As shown in Table 1 and FIG. 6, it was confirmed that the maximum temperature of the positive electrode side edge portion tends to drop when the core portion is brought into close proximity with the negative electrode terminal and distanced from the positive electrode terminal (in other words, when increasing L1/L2). On the other hand, it was confirmed that the maximum temperature of the negative electrode side edge portion tends to rise when increasing L1/L2. In addition, as shown in FIG. 6, when L1/L2 exceeds 1.8, it is expected that the maximum temperature of the negative electrode side edge portion is to exceed the maximum temperature (154° C.) of the positive electrode side edge portion of sample 1 (a reversal in temperature distribution is to occur and a localized temperature rise in the vicinity of the negative electrode side edge portion is to occur). From the above, it was found that a localized temperature rise in a specific region can be prevented by forming the core portion such that the distance L1 and the distance L2 satisfy 1<L1/L2<1.8. Furthermore, as shown in FIG. 7, it was confirmed that a difference between the distance L1 and the distance L2 (L1−L2) exhibits tendencies similar to those of L1/L2.

### (2) Withstand Voltage Test

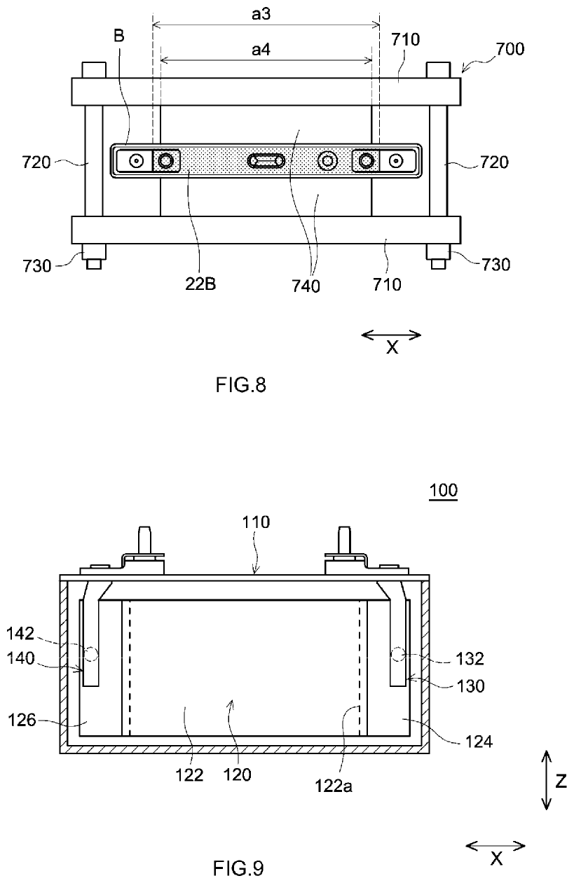

In the present test, an overcharge test was performed while constraining the test batteries of samples 1 to 3 at prescribed pressure to study voltage at which an internal short circuit due to a contraction of the separator occurs. A constraining instrument 700 shown in FIG. 8 was used to constrain the test batteries. The constraining instrument 700 includes a pair of opposing constraining plates 710, a bridging member 720 which bridges the constraining plates 710, a nut 730 attached to one end of the bridging member 720, and clamping members 740 which clamp and hold a test battery B. In the constraining instrument 700, a constraint load acting on the test battery B can be adjusted by arranging the test battery B between the clamping members 740 and tightening the nut 730. In the present test, the constraint load on the test battery B was set to 3000 N.

A width a4 of the clamping members 740 is set to be shorter than the width a3 of the core portion 22 of the test battery B. In the present test, positions where the clamping members 740 clamp the test battery B were varied and an overcharge test was performed at each of three different constrained states (refer to Table 2). In the overcharge test, in a temperature environment of 60° C., a constant current charge (CC charge) was performed at a current value (a charge rate) of 190 A from a state of SOC 15%. The charge was continued until an internal short circuit occurred and voltage at a time point of the occurrence of the internal short circuit was measured. Evaluation results are shown in Table 2.

TABLE 2

| | Sample 1 | Sample 2 | Sample 3 |
|---|---|---|---|
| No constraints on side edge portions | 17 V | 15 V | 20 V |
| Constraint only on negative | 17 V | 15 V | 20 V |
| electrode side edge portion | | | |
| Constraint only on positive | 25 V | 20 V | 30 V |
| electrode side edge portion | | | |

As shown in Table 2, with sample 3 in which the core portion was formed so as to satisfy 1<L1/L2<1.8, it was confirmed that internal short circuit is less likely to occur than the other samples regardless of the constrained state.

In addition, with all samples, it was confirmed that an occurrence of an internal short circuit is suppressed by constraining the positive electrode side edge portion. From the above, it was understood that a contraction of the separator can be more preferably suppressed by arranging the respective unit cells so that an appropriate constraint load acts on the positive electrode side edge portion of the core portion when constructing the assembled battery. Furthermore, in sample 3, it was confirmed that a short circuit-suppressing effect larger than that of other samples was produced when constraining the positive electrode side edge portion.

While specific examples of the present disclosure have been described in detail, such specific examples are merely illustrative and are not intended to limit the scope of claims. Techniques described in the scope of claims include various modifications and changes made to the specific examples illustrated above.

What is claimed is:

1. A sealed battery, comprising:
an electrode body in which a sheet-shaped positive electrode and a sheet-shaped negative electrode are laminated via a separator;
a flat square case which houses the electrode body;
a positive electrode terminal, which is an electrode terminal including aluminum or an aluminum alloy, which is electrically connected to the positive electrode inside the case and of which a part is exposed to the outside of the case; and
a negative electrode terminal, which is an electrode terminal including copper or a copper alloy, which is electrically connected to the negative electrode inside the case and of which a part is exposed to the outside of the case, wherein
the positive electrode has a foil-like positive electrode current collector including aluminum or an aluminum alloy and a positive electrode mixture layer formed on a surface of the positive electrode current collector, and a positive electrode exposed portion in which the positive electrode mixture layer is not formed and the positive electrode current collector is exposed is formed in one side edge portion in a width direction,
the negative electrode has a foil-like negative electrode current collector including copper or a copper alloy and a negative electrode mixture layer formed on a surface of the negative electrode current collector, and a negative electrode exposed portion in which the negative electrode mixture layer is not formed and the negative electrode current collector is exposed is formed in another side edge portion in the width direction,
a core portion in which the positive electrode mixture layer and the negative electrode mixture layer oppose each other is formed in a center portion in the width direction of the electrode body, a positive electrode connecting portion on which the positive electrode exposed portion is laminated is formed on the one side edge portion in the width direction, and a negative electrode connecting portion on which the negative electrode exposed portion is laminated is formed on the other side edge portion in the width direction,
the positive electrode connecting portion and the positive electrode terminal are connected at a positive electrode-connected location, and the negative electrode connecting portion and the negative electrode terminal are connected at a negative electrode-connected location, and wherein
a distance L1 is a shortest distance between a positive electrode side edge portion that is a side edge portion of the core portion on a side of the positive electrode connecting portion and a side edge portion on a core portion side of the positive electrode-connected location,
a distance L2 is a shortest distance between a negative electrode side edge portion that is a side edge portion of the core portion on a side of the negative electrode connecting portion and a side edge portion on a core portion side of the negative electrode-connected location, and
the core portion is formed such that the distance L1 and the distance L2 satisfy the following expression (1):
1<L1/L2<1.8 (1).

2. The sealed battery according to claim 1, wherein a difference between the distance L1 and the distance L2 (L1−L2) is 4.3 mm or less.

3. An assembled battery comprising a plurality of unit cells, wherein
each of the plurality of unit cells is the sealed battery according to claim 1,
each of the unit cells is arranged so that the positive electrode terminal and the negative electrode terminal are in close proximity with each other between adjacent cells and, at the same time, broad width surfaces of flat square cases oppose each other,
the positive electrode terminal and the negative electrode terminal are electrically connected to each other via a busbar between the adjacent unit cells,
a constraining member is provided which constrains each of the unit cells in an arrangement direction of the unit cells, and
the positive electrode side edge portion of each of the unit cells is arranged closer to a center side in a width direction than the negative electrode side edge portion of the unit cell.

4. The assembled battery according to claim 3, wherein a plate-shaped spacer is arranged between the respective unit cells.

5. The assembled battery according to claim 4, wherein a length in the width direction of the spacer is longer than a length in the width direction of the core portion.
